(19) United States
(12) Patent Application Publication
(10) Pub. No.: US 2025/0004278 A1
(43) Pub. Date: Jan. 2, 2025

(54) VIRTUAL IMAGE DISPLAY DEVICE AND OPTICAL UNIT

(71) Applicant: SEIKO EPSON CORPORATION, Tokyo (JP)

(72) Inventor: Takashi TAKEDA, SUWA-SHI (JP)

(73) Assignee: SEIKO EPSON CORPORATION, Tokyo (JP)

(21) Appl. No.: 18/757,465

(22) Filed: Jun. 27, 2024

(30) Foreign Application Priority Data
Jun. 30, 2023 (JP) 2023-107971

(51) Int. Cl. G02B 27/01; G02B 15/14; G02B 27/28

(52) U.S. Cl. CPC G02B 27/0172; G02B 15/1431; G02B 27/28; G02B 2027/0116; G02B 2027/0178

(57) ABSTRACT

A virtual image display device includes: a first lens that has a positive refractive power and on which video light from the display element is incident, a second lens that has a positive refractive power and on which the video light passed through the first lens is incident, a prism light-guiding member that includes a first prism and a second prism, a polarized light separation film that is provided at a bonding position of the first prism and the second prism, a third lens that is disposed facing an outer surface of the first prism and that has a plano-convex shape, a transmissive mirror that is disposed on a convex surface of the third lens and that is configured to partially reflect the video light, and a quarter-wavelength plate disposed between the outer surface and the flat surface of the third lens.

The present application is based on, and claims priority from JP Application Serial Number 2023-107971, filed Jun. 30, 2023, the disclosure of which is hereby incorporated by reference herein in its entirety.

### BACKGROUND

### 1. Technical Field

The present disclosure relates to a virtual image display device and an optical unit that are a see-through type and that enable observation of a virtual image.

### 2. Related Art

A known head-mounted display includes a display device, a projection optical member, a prism member, and an optical condensing/reflecting surface, and image light from the projection optical member is incident into a first prism included in the prism member, totally reflected at an outer surface of the prism member, partially reflected at a semi-transmissive reflective surface formed at a boundary between the first prism and a second prism included in the prism member, then transmitted through the outer surface of the prism member, reflected at the condensing/reflecting surface, returned to the prism member, transmitted through the semi-transmissive reflective surface, and further passed through an inner surface facing a pupil (see JP 2020-08749 A).

In the head-mounted display described above, since an intermediate image is formed in the first prism, an optical path length becomes long, and an optical system becomes large as a whole. In addition, since the projection optical member is disposed in a direction inclined toward a face with respect to the above of the prism member, the projection optical member is disposed close to the face and interference is likely to occur, so that the projection optical member is limited in arrangement and size. Even when a relatively small optical system that does not form an intermediate image can be achieved by effectively using an optical condensing/reflecting plate, in such an optical system, it is difficult to correct color aberration only by using the optical condensing/reflecting plate.

### SUMMARY

According to an aspect of the present disclosure, there is provided a virtual image display device being a direct virtual image type, the virtual image display device including a display element configured to emit video light, a first lens having a positive refractive power, on which the video light is incident from the display element, a second lens having a positive refractive power, on which the video light passed through the first lens is incident, a prism light-guiding member including a first prism and a second prism, the prism light-guiding member having a parallel flat plate shape, the prism light-guiding member being configured to cause the video light passed through the second lens to be guided, a polarized light separation film provided at a bonding position of the first prism and the second prism, the polarized light separation film having a flat surface shape, the polarized light separation film being configured to selectively reflect the video light guided in the first prism in accordance with a polarization direction, a third lens including a flat surface disposed facing an outer surface of the first prism, the third lens having a plano-convex shape, on which the video light reflected at the polarized light separation film is incident, a transmissive mirror formed on a convex surface of the third lens, the transmissive mirror being configured to partially reflect the video light reflected at the polarized light separation film toward the polarized light separation film, and a quarter-wavelength plate disposed between the outer surface of the first prism and the flat surface of the third lens, the quarter-wavelength plate being for the video light. A refractive index of the first prism is higher than refractive indices of the first lens and the third lens. The virtual image display device suppresses, as a whole, color aberration due to combination of the first lens, the second lens, the first prism, and the third lens.

According to an aspect of the present disclosure, there is provided an optical unit being a direct virtual image type, the optical unit including a first lens having a positive refractive power, on which video light from a display element configured to emit the video light is incident, a second lens having a positive refractive power, on which the video light passed through the first lens is incident, a prism light-guiding member including a first prism and a second prism, the prism light-guiding member having a parallel flat plate shape, the prism light-guiding member being configured to cause the video light passed through the second lens to be guided, a polarized light separation film provided at a bonding position of the first prism and the second prism, the polarized light separation film having a flat surface shape, the polarized light separation film being configured to selectively reflect the video light guided in the first prism in accordance with a polarization direction, a third lens including a flat surface disposed facing an outer surface of the first prism, the third lens having a plano-convex shape, on which the video light reflected at the polarized light separation film is incident, a transmissive mirror formed on a convex surface of the third lens, the transmissive mirror being configured to partially reflect the video light reflected at the polarized light separation film toward the polarized light separation film, and a quarter-wavelength plate disposed between the outer surface of the first prism and the flat surface of the third lens, the quarter-wavelength plate being for the video light. A refractive index of the first prism is higher than refractive indices of the first lens and the third lens. The optical unit suppresses, as a whole, color aberration due to combination of the first lens, the second lens, the first prism, and the third lens.

### BRIEF DESCRIPTION OF THE DRAWINGS

FIG. 1 is an external view for describing a used state of a virtual image display device according to a first embodiment.

FIG. 2 is a side cross-sectional view for describing an internal structure of a display device on one side.

FIG. 3 is a perspective view for describing an external structure of a first display unit.

FIG. 4 is a diagram for describing shapes and the like of a first image forming element and a first lens.

FIG. 5 is a perspective view for describing an example of a structure and assembly of the first display unit.

FIG. 6 is a diagram for describing color aberration and suppression of the color aberration.

FIG. 7 is a side cross-sectional view for describing an internal structure of a virtual image display device according to a second embodiment.

FIG. 8 is a side cross-sectional view for describing a virtual image display device according to a third embodiment.

FIG. 9 is a conceptual diagram for describing an operation of the virtual image display device illustrated in FIG. 8.

FIG. 10 is a conceptual diagram for describing an operation of a modification of the virtual image display device illustrated in FIG. 8.

### DESCRIPTION OF EMBODIMENTS

### First Embodiment

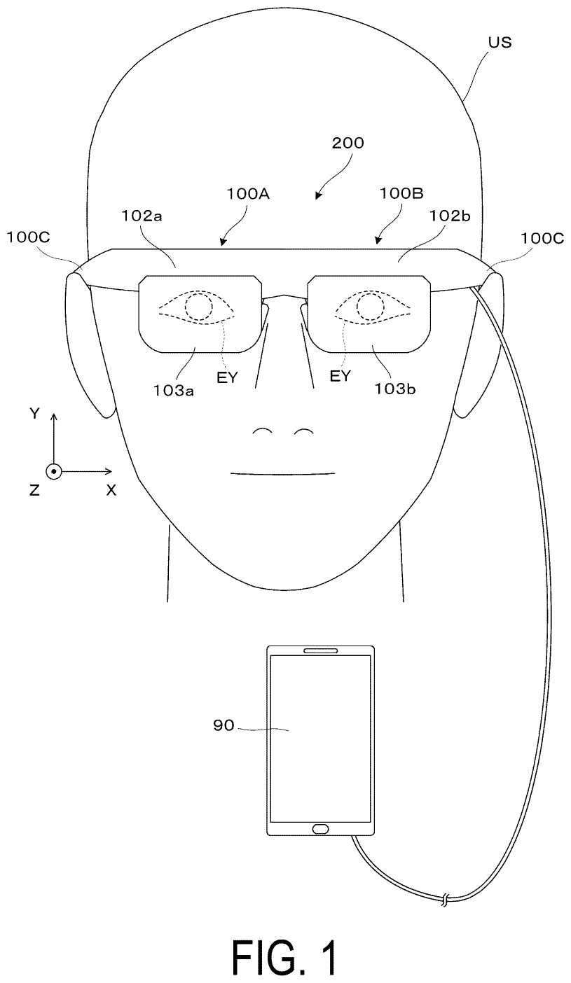

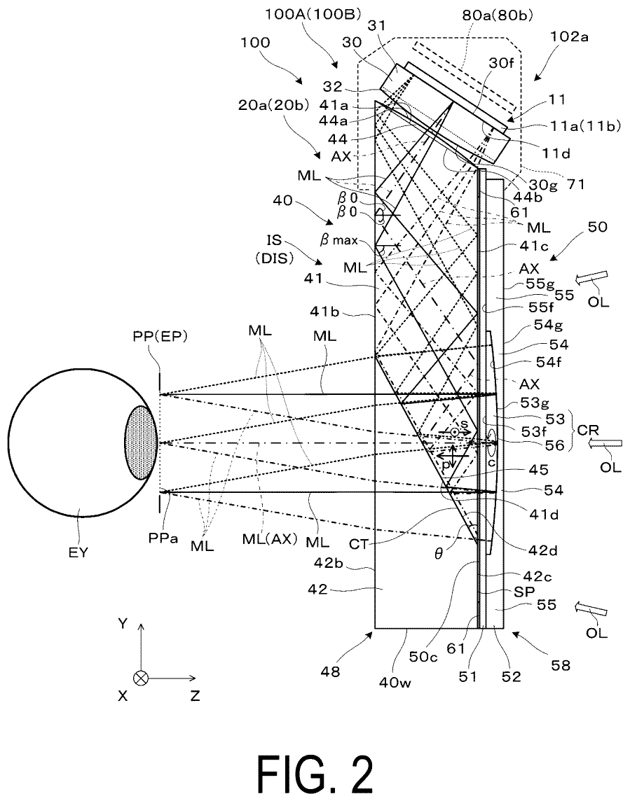

A first embodiment of a virtual image display device and the like according to the present disclosure will be described below with reference to FIGS. 1, 2 and the like.

FIG. 1 is a diagram for describing a mounted state of a head-mounted virtual image display device (hereinafter, also referred to as a head-mounted display or an “HMD”) 200, and the HMD 200 allows an observer or wearer US who is wearing the HMD 200 to recognize a video as a virtual image. In FIG. 1 and the like, X, Y, and Z indicate an orthogonal coordinate system, a +X direction corresponds to a lateral direction in which both eyes EY of the observer or wearer US wearing the HMD 200 are aligned, a +Y direction corresponds to an upward direction orthogonal to the lateral direction in which both the eyes EY are aligned for the wearer US, and a +Z direction corresponds to a forward or front direction for the wearer US. The +Y directions are parallel to a vertical axis or a vertical direction.

The HMD 200 includes a first virtual image display device 100A that is for a right eye and of a direct virtual image type, a second virtual image display device 100B that is for a left eye and of a direct virtual image type, a pair of support devices 100C that have a temple shape and that support the virtual image display devices 100A and 100B, and a user terminal 90 as an information terminal. The first virtual image display device 100A alone functions as an HMD, and is constituted by a first display driving unit 102a disposed at an upper portion thereof, and a first combiner 103a that has a spectacle lens shape and that covers a front of the eye. Similarly, the second virtual image display device 100B alone functions as an HMD, and is constituted by a second display driving unit 102b disposed at an upper portion thereof, and a second combiner 103b that has a spectacle lens shape and that covers a front of the eye. The support devices 100C are mounting members to be mounted on the head of the wearer US, and support upper end sides of the pair of combiners 103a and 103b by using the display driving units 102a and 102b that are integrated in appearance. The first virtual image display device 100A and the second virtual image display device 100B are optically identical or inverted to each other in a left-right direction, and detailed description of the second virtual image display device 100B will be omitted.

FIG. 2 is a side cross-sectional view for describing an internal structure of the first virtual image display device 100A. The first virtual image display device 100A includes a first image forming element 11a, a first display unit 20a, and a first circuit member 80a. The first image forming element 11a is also referred to as a display element 11. The first display unit 20a is an imaging optical system IS that directly forms a virtual image without forming an intermediate image and is also referred to as a direct virtual image optical system DIS. The imaging optical system IS includes a first lens 30, a first flat plate member 40, and a second flat plate member 50. The first lens 30 functions as a protective glass that protects a display surface 11d of the display element 11. The first flat plate member 40 includes a second lens 44 facing the first lens 30, and guides the video light ML that has been emitted from the display element 11 and that has been incident from the second lens 44 to the third lens 53 of the second flat plate member 50. The second flat plate member 50 reflects the video light ML toward a pupil position PP or an eye EY by partially returning the video light ML from the first flat plate member 40 to the first flat plate member 40, and causes an external light to be incident at the pupil position PP through the first flat plate member 40. Each of the first lens 30, the second lens 44, the first flat plate member 40, and the second flat plate member 50 has a function as a lens having a positive refractive power.

Although detailed description will be omitted, the second virtual image display device 100B includes a second image forming element 11b, a second display unit 20b, and a second circuit member 80b. The second image forming element 11b is similar to the first image forming element 11a, the second display unit 20b is similar to the first display unit 20a, and the second circuit member 80b is similar to the first circuit member 80a.

In the first virtual image display device 100A, the first image forming element 11a is an image light generating device of a self-luminous type. The first image forming element 11a emits the video light ML to the first flat plate member 40 through the first lens 30. The first image forming element 11a is housed in and supported by a case 71. The first image forming element 11a is, for example, an organic electro-luminescence (EL) display, and forms a color still image or moving image on the display surface 11d that is two-dimensional. The first image forming element 11a is driven by the first circuit member 80a to perform a display operation. The first image forming element 11a is not limited to the organic EL display, and may be replaced with a display device using inorganic EL, an organic LED, an LED array, a laser array, a quantum dot light-emitting element, or the like. The first image forming element 11a is not limited to the image light generating device of the self-luminous type, and it may be possible to employ a device including an LCD or other optical modulation elements and illuminating the optical modulation elements using a light source such as backlight to form an image. As for the first image forming element 11a, it may be possible to use liquid crystal on silicon (LCOS, LCOS is a registered trademark), a digital micro-mirror device, or the like, instead of the LCD. Note that an optical device obtained by excluding the first circuit member 80a from the first virtual image display device 100A is referred to as an optical unit 100. It can also be said that the optical unit 100 includes an optical system of a direct virtual image type and is a portion corresponding to the direct virtual image optical system DIS constituting the first virtual image display device 100A.

The first display unit 20a includes the first lens 30, the first flat plate member 40, a polarized light separation film 45, and the second flat plate member 50. In the first display unit 20a, the first lens 30 has a positive refractive power, and is incident thereon with the video light ML from the first image forming element 11a. The first lens 30 includes a light incident surface 30f being a flat surface and bonded to the first image forming element 11a and a light emission surface 30g being a convex surface. The light emission surface 30g is, for example, a spherical surface, but may be an aspherical surface having an axially symmetric shape. The first lens 30 can be considered to be divided into a parallel flat plate 31 and a lens portion 32. Ensuring that a thickness of the parallel flat plate 31 is equal to or larger than a predetermined value causes a foreign matter adhering to a surface of the first lens 30 to become less noticeable. The lens portion 32 is a plano-convex lens having a positive refractive power. In the plano-convex lens, one surface has a flat surface shape and the other surface has a convex surface shape. The first lens 30 is made of fused quartz, for example, and has a relatively low refractive index. As an example, the refractive index of the first lens 30 is equal to or less than 1.49. Preferably, the first lens 30 is made of a quartz having a refractive index of 1.46.

The first flat plate member 40 includes a second lens 44 being a plano-convex lens, a first prism 41 having a parallel flat plate shape, and a second prism 42 having a parallel flat plate shape. The second lens 44 and the first prism 41 are bonded at inclined surfaces 44b and 41a. The first prism 41 and the second prism 42 are bonded at inclined surfaces 41d and 42d. The second lens 44, the first prism 41, and the second prism 42 that are bonded to one another are referred to as a prism light-guiding member 48. The prism light-guiding member 48 has an appearance of a parallel flat plate. The polarized light separation film 45 having a flat surface shape is formed on the inclined surface 41d formed at the lower side of the first prism 41. A combination of the prism light-guiding member 48 and the second flat plate member 50, which will be described later, corresponds to the first combiner 103a in FIG. 1.

The second lens 44 is a plano-convex lens having a positive refractive index, and includes an incident optical surface 44a facing the light emission surface 30g of the first lens 30 and an inclined surface 44b bonded to the first prism 41. As an example, the refractive index of the second lens 44 is equal to or less than 1.49. Preferably, the second lens 44 is made of a quartz having a refractive index of 1.46. The first prism 41 has an outer shape of a quadratic prism shape and includes a trapezoidal vertical cross section. The first prism 41 guides the video light ML, and includes the inclined surface 41a combined with the inclined surface 44b of the second lens 44, an inner surface 41b, an outer surface 41c, and the inclined surface 41d. Here, the incident optical surface 44a is inclined downward and forward as a whole, and an optical axis passing through the incident optical surface 44a extends in a direction between the +Z direction that is forward and the +Y direction that is upward. Accordingly, the first image forming element 11a that is the display element 11 can be easily disposed at the further external environment side than the inner surface 41b, and an angle at which the video light ML propagates in the first prism 41 (in the first prism 41 or inside the first prism 41) can be adjusted. The incident optical surface 44a is a convex surface, for example, a spherical surface, but may also be an aspherical surface having an axially symmetric shape. The inner surface 41b and the outer surface 41c are parallel to each other, and extend perpendicularly to an optical axis AX between the pupil position PP, and the inner surface 41b and the outer surface 41c. The inner surface 41b and the outer surface 41c internally reflect the video light ML (that is, reflect the video light ML at an inner side of an object surface), and in particular, it is desirable that the inner surface 41b and the outer surface 41c totally reflect the video light ML. Applying hard coating to the inner surface 41b can enhance scratch resistance or abrasion resistance. The inclined surface 41d is a flat surface. The inclined surface 41d forms an acute angle with respect to the outer surface 41c. To be specific, the inclined surface 41d forms an angle of 25° to 32°. Note that an interval between the optical axis AX passing through the pupil position PP and an upper end of the first lens 30 is about 20 mm. The first prism 41 is formed of an optical glass such as s-NBH51 and has a refractive index higher than the refractive index of the first lens 30.

The number of reflections of the video light ML in the first prism 41 is one at the inner surface 41b, one at the outer surface 41c, and further one at the polarized light separation film 45, which will be described later. Setting the number of internal reflections of the video light ML in the first prism 41 to two makes it possible to avoid mixing of light having the different number of reflections in the first prism 41 while increasing the angle of view of the video light ML, and the pupil position PP or an aperture PPa thereof. Since an intermediate image is not formed in the first display unit 20a or the imaging optical system IS, the video light ML reflected by the inner surface 41b and the outer surface 41c is less diverged than the video light ML initially emitted from the first image forming element 11a. However, the video light ML is incident on the inner surface 41b and the outer surface 41c in the diverged state, and the diverged state is maintained.

Similarly to the first prism 41, the second prism 42 has an outer shape of a quadratic prism and a trapezoidal vertical cross section. The second prism 42 transmits the video light ML, and includes an inner surface 42b, an outer surface 42c, and an inclined surface 42d. Here, the inner surface 42b and the outer surface 42c are parallel to each other and extend perpendicularly to the optical axis AX between the pupil position PP, and the inner surface 42b and the outer surface 42c. Applying hard coating to the inner surface 42b can enhance scratch resistance or abrasion resistance of the inner surface 42b. The second prism 42 is formed of an optical glass such as s-NBH51 and has a refractive index equal to a refractive index of the first prism 41. As an example, differences between the refractive indices of the first lens 30 and the second lens 44 and the refractive index of the first prism 41 and the second prism 42 are equal to or more than 0.17. As another example, the refractive index of the first prism 41 and the second prism 42 is equal to or more than 1.67. Preferably, the first prism 41 and the second prism 42 are made of an optical glass having a refractive index of 1.67.

The polarized light separation film 45 is integrally formed on the inclined surface 41d of the first prism 41, and is interposed between the inclined surface 41d of the first prism 41 and the inclined surface 42d of the second prism 42. A space between the polarized light separation film 45 and the inclined surface 42d is filled with an adhesive CT for bonding. The polarized light separation film 45 is formed of a dielectric multilayer film, efficiently reflects the video light ML of s-polarized light s when the video light ML includes the s-polarized light s, and efficiently transmits the video light ML of p-polarized light p when the video light ML includes the p-polarized light p. The polarized light separation film 45 may be any film that selectively reflects the video light ML in accordance with a polarization direction, and may be, for example, a wire grid type polarizer. The polarized light separation film 45 may be a flat surface to such an extent that the polarized light separation film 45 does not affect imaging. In addition, the polarized light separation film 45 may include a slightly curved surface that is convex or concave to such an extent that the polarized light separation film 45 does not affect imaging. Note that a space between the polarized light separation film 45 and the inclined surface 41d may be filled with a transmissive filler instead of the adhesive CT. In this case, the first prism 41 and the second prism 42 may be supported by a support member or the like from the outside to maintain a joined state. Further, the polarized light separation film 45 may be integrally formed on the inclined surface 42d of the second prism 42 instead of the inclined surface 41d of the first prism 41. Applying hard coating on the surface of the polarized light separation film 45 can enhance scratch resistance or abrasion resistance thereof.

When a reflection angle of the video light ML on the optical axis AX in the first prism 41 is β0, an inclination angle θ of the polarized light separation film 45 is equal to or more than 90°−β0. On the assumption that the polarized light separation film 45 does not obstruct a path of the video light ML, when a maximum reflection angle of the video light ML is βmax, the inclination angle θ of the polarized light separation film 45 is desirably smaller than βmax. The reflection angle β0 of the video light ML corresponds to an angle formed by a normal line of the inner surface 41b and the optical axis AX passing through the incident optical surface 44a, and is an acute angle. That is, the optical axis AX of the incident optical surface 44a extends in a direction forming an angle less than 90° with respect to the normal line of the inner surface 41b.

The second flat plate member 50 includes a quarter-wavelength plate 51 having a thin plate shape and a cover member 52. The quarter-wavelength plate 51 is a crystal or the like having an optical axis between the X direction and the Y direction, converts the video light ML of the s-polarized light s reflected by the polarized light separation film 45 into circularly polarized light c, and converts the video light ML of the circularly polarized light c reflected by the cover member 52 into p-polarized light p. The cover member 52 includes the third lens 53 having a plano-convex shape, a compensation lens 54 having a plano-concave shape, a compensation flat plate 55 provided around the compensation lens 54, and a transmissive mirror 56.

The second flat plate member 50 is disposed so as to be separated from the first flat plate member 40 by an interval about from 20 μm to 50 μm. The outer surfaces 41c and 42c of the first flat plate member 40 and an inner surface 50c of the second flat plate member 50 may be slightly curved, and a minute step may be formed at a boundary between the outer surfaces 41c and 42c. However, by setting an interval between the outer surfaces 41c and 42c and the inner surface 50c to be equal to or more than 20 μm, more preferably equal to or more than 30 μm, these surfaces can be prevented from being excessively close to each other. On the other hand, by setting the interval between the outer surfaces 41c and 42c and the inner surface 50c to be equal to or less than 50 μm, it is possible to avoid an increase in thickness of the first combiner 103a including the first flat plate member 40 and the second flat plate member 50. Between the outer surfaces 41c and 42c of the first flat plate member 40 and the inner surface 50c of the second flat plate member 50, there is provided the spacers 61 for adjusting the interval between the first flat plate member 40 and the second flat plate member 50 and fixing the first flat plate member 40 and the second flat plate member 50 in a mutually positioned state. The spacer 61 is not provided over the entire periphery of the second flat plate member 50. That is, a gap SP between the first flat plate member 40 and the second flat plate member 50 is not sealed and communicates with the external environment.

In the cover member 52, the third lens 53 is thin but has a positive refractive power, and includes a flat surface 53f bonded to the quarter-wavelength plate 51 and a convex surface 53g facing the compensation lens 54. The convex surface 53g is, for example, a spherical surface, but may also be an aspherical surface having an axially symmetric shape. The compensation lens 54 is thin but has a positive refractive power and includes a concave surface 54f facing the third lens 53 and a flat surface 54g. The compensation flat plate 55 is a parallel flat plate, and includes a pair of flat surfaces 55f and 55g. Here, the concave surface 54f of the compensation flat plate 55 has the same shape as that of the convex surface 53g of the third lens 53. The flat surface 54g of the compensation lens 54 and the flat surface 55g of the compensation flat plate 55 are continuous on the same plane. The transmissive mirror 56 is a thin film formed on the convex surface 53g of the third lens 53, and has the same shape as that of the convex surface 53g. A combination of the third lens 53 and the transmissive mirror 56 is referred to as an optical condensing/reflecting portion CR.

The third lens 53, the compensation lens 54, and the compensation flat plate 55 are formed of a resin material, and have the same refractive index. A refractive index of the third lens 53 and the like is lower than the refractive index of the first prism 41. As an example, the refractive index of the third lens 53 is 1.49. As another example, a difference between the refractive index of the third lens 53 and the refractive index of the first prism 41 is equal to or more than 0.17. Preferably, the third lens 53 is made of an acrylic such as PMMA having a refractive index of 1.49. The compensation lens 54 and the compensation flat plate 55 are an optical element 58 integrally made of the same resin material. A combination of the third lens 53, the compensation lens 54 and the compensation flat plate 55 functions as a parallel flat plate as a whole. That is, the external light OL incident at a position of the compensation lens 54 or the compensation flat plate 55 passes through the compensation lens 54 or the compensation flat plate 55 without being affected by a lens effect by the compensation lens 54 or the like or a step present at an outer edge of the compensation lens 54. The flat surfaces 54g and 55g of the compensation lens 54 and the compensation flat plate 55 may be provided with an antireflective film or be subjected to hard coating. The external light OL passed through the compensation flat plate 55 passes through the upper, lower, left, and right sides of the compensation lens 54, and is incident from a peripheral region outside the incident region of the video light ML corresponding to the compensation lens 54, that is, from the compensation flat plate 55. This makes it possible to ensure a wide see-through visual field for an external environment. A visual field range of the external light OL is set to, for example, about 40° in the upward direction and about 40° in the downward direction.

A diameter of the third lens 53 is set to be from 20 mm to 25 mm from the viewpoint of securing the angles of view. Note that since a thickness of the first flat plate member 40 or the prism light-guiding member 48 in the Z direction is from 6 mm to 8 mm and distances from the inner surfaces 41b and 42b of the first flat plate member 40 to the pupil position PP are about from 12 mm to 13 mm, the angle of view (diagonal angle of view) that is an angle range in which the video light ML is incident at the pupil position PP can be set to about 40°.

The transmissive mirror 56 is a half mirror, and partially reflects the video light ML passed through the third lens 53 and partially transmits the external light OL. The transmissive mirror 56 reflects the video light ML that has been reflected at the polarized light separation film 45 of the first flat plate member 40 and then has passed through the quarter-wavelength plate 51 and the third lens 53, toward the pupil position PP. The transmissive mirror 56 is a concave mirror that covers the pupil position PP at which the eye EY or the pupil is disposed, that has a concave shape toward the pupil position PP, and that has a convex shape toward the external environment. The pupil position PP or the aperture PPa thereof is referred to as an eye point or an eye box, and corresponds to an emission pupil EP of the first display unit 20a.

The transmissive mirror 56 transmits a part of the external light OL therethrough, which enables see-through view of the external environment, and thus enables a virtual image to be superimposed on an external image. At this time, the external light OL passes through the first flat plate member 40 and the second flat plate member 50, but the flat plate members 40 and 50 do not cause a lens effect on the external light OL. A reflectance of the transmissive mirror 56 for each of the video light ML and the external light OL is set to a value equal to or more than 10% and equal to or less than 50% in an incident angle range of the assumed video light ML from the viewpoint of ensuring a brightness of the video light ML and facilitating see-through observation of the external image. The transmissive mirror 56 is formed of, for example, a dielectric multilayer film constituted by a plurality of dielectric layers each of which has an adjusted film thickness. The transmissive mirror 56 may be a single layer film or a multilayer film of a metal such as Al or Ag. In this case, a film thickness thereof has been adjusted. The transmissive mirror 56 is formed by, for example, lamination using vapor deposition.

In the first virtual image display device 100A, each of the first lens 30, the second lens 44, the third lens 53, and the transmissive mirror 56 has a positive refractive power and causes divergent light to have a converging tendency. The first lens 30, the second lens 44, the third lens 53, and the transmissive mirror 56, including a main body of the first prism 41, the second prism 42, and the like, function as an imaging optical system IS or a direct virtual image optical system DIS such as a simple microscope type of microscope that forms an erect image. Thus, a real image formed on the display surface 11d of the first image forming element 11a can be formed as a virtual image projected to the infinity, for example, or a real image formed on the display surface 11d can be formed as a virtual image projected several meters ahead. At this time, adjusting refractive powers of the first lens 30, the second lens 44, the third lens 53, and the transmissive mirror 56 causes a focal length of the imaging optical system IS to be shortened to achieve a desired magnification rate. Additionally, in the first virtual image display device 100A, it is preferable that the refractive indices of the first lens 30, the second lens 44, the first prism 41, and the third lens 53 be appropriately set based on the dimensions and shapes of the first lens 30, the second lens 44, the first prism 41, the third lens 53, and the transmissive mirror 56 so as to suppress color aberration due to the combination of the first lens 30, the second lens 44, the first prism 41, and the third lens 53 as a whole. More specifically, the color aberration is suppressed in the entire optical system that forms a virtual image on an optical path. The optical path passes through the first lens 30, passes through the second lens 44, is bent by the first prism 41, reciprocates in the quarter-wavelength plate by reflection at the transmissive mirror 56, reciprocates in the third lens 53, and passes through the first and second prisms.

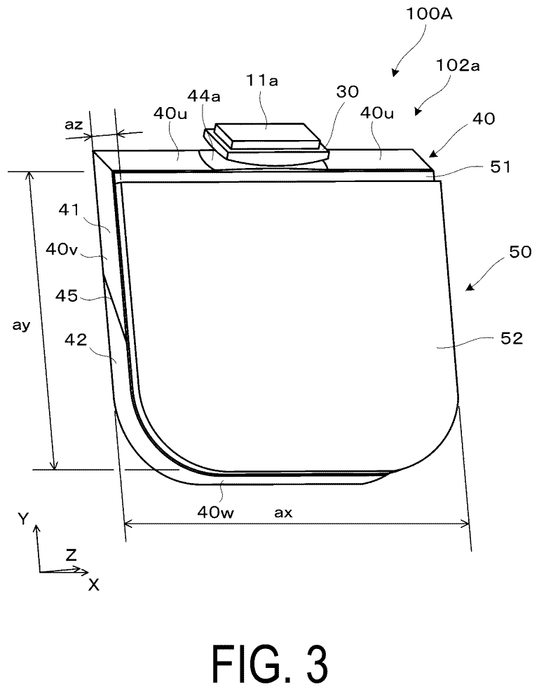

Referring to FIG. 3, a size ay in the vertical direction of the first flat plate member 40 or the second flat plate member 50 is, for example, 34 mm, and a size ax in the horizontal direction thereof is, for example, 40 mm. A thickness az of the first flat plate member 40 in a front-rear direction is, for example, about 7 mm, and a total thickness of the first flat plate member 40 and the second flat plate member 50 is suppressed to about 7.5 mm. In the first flat plate member 40, upper flat surfaces 40u are provided on the left and right sides of the incident optical surface 44a. Light is not incident on the upper flat surfaces 40u. From the viewpoint of preventing stray light, a light-shielding body (not illustrated) may be disposed on the upper flat surface 40u so as to face the upper flat surface 40u and to cover the upper flat surface 40u, or the light-shielding body may be coated on the upper flat surface 40u. Each of side flat surfaces 40v and a lower flat surface 40w may also be provided with a light-shielding body or the like for covering the surface. A light-shielding body or the like covering the periphery of the second flat plate member 50 can also be provided.

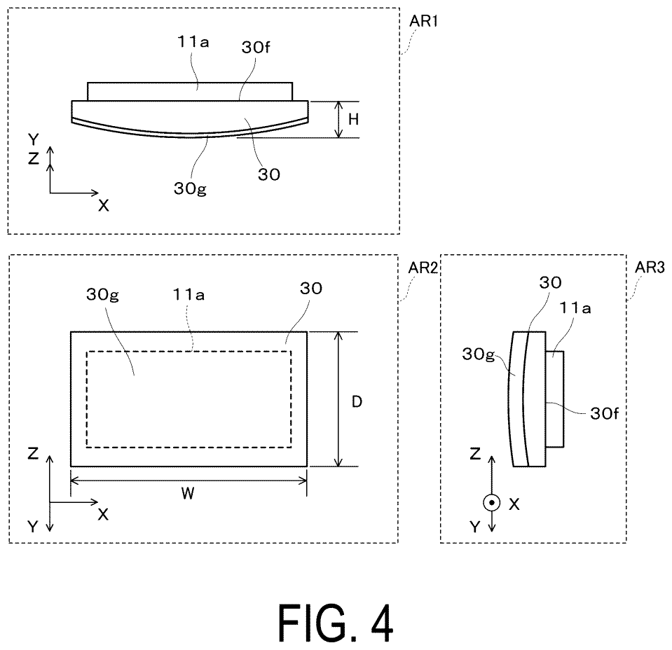

With reference to FIG. 4, shapes and the like of the first image forming element 11a and the first lens 30 will be described. In FIG. 4, a region AR1 indicates a state in which the first lens 30 and the like are viewed obliquely upward from the +Z side set as the front side, a region AR2 indicates a state in which the first lens 30 and the like are viewed obliquely forward from the −Y side set as the lower side, and a region AR3 indicates a state in which the first lens 30 and the like are viewed from the +X side set as the lateral side. A thickness or height H of the first lens 30 is, for example, approximately 2 mm, a width W of the first lens 30 is, for example, approximately 14 mm, and a depth D of the first lens 30 is, for example, approximately 7 mm.

A curvature radius of the light emission surface 30g with a convex shape of the first lens 30 is, for example, 20 mm. In addition, a curvature radius of the incident optical surface 44a of the first prism 41 is, for example, 14 mm, and a curvature radius of the transmissive mirror 56 is, for example, 47 mm. Each of the incident optical surface 44a of the first prism 41 and the surface of the transmissive mirror 56 and the like is not limited to a spherical surface and may be a coaxial aspherical surface.

An optical path will be described. The video light ML from the first image forming element 11a is incident on the first prism 41 through the first lens 30 and the second lens 44. At this time, the degree of divergence of the video light ML is suppressed by the positive refractive powers of the first lens 30 and the second lens 44. In the optical path passing through the first prism 41, the video light ML is sequentially reflected by the inner surface 41b of the first prism 41 and the outer surface 41c of the first prism 41 without forming an intermediate image, and an s-component of the video light ML is reflected at the polarized light separation film 45. The video light ML of the s-polarized light s reflected at the polarized light separation film 45 is transmitted through the outer surface 41c of the first prism 41, is transmitted through the quarter-wavelength plate 51 of the second flat plate member 50 to become the circularly polarized light c, and then is incident on the transmissive mirror 56. The video light ML of the circularly polarized light c incident on the transmissive mirror 56 passes through the third lens 53, is partially reflected at the transmissive mirror 56, passes through the third lens 53, and passes through the quarter-wavelength plate 51 again in a collimated state. Accordingly, the video light ML that has passed through the quarter-wavelength plate 51 becomes p-polarized light p, is incident on the first prism 41 from the outer surface 41c, is transmitted through the polarized light separation film 45, and is emitted outside the second prism 42 through the inner surface 42b. The video light ML emitted outside the second prism 42 is incident at the pupil position PP at which the eye EY or pupil of the wearer US is placed. Not only the video light ML reflected at the transmissive mirror 56 but also the external light OL transmitted through the transmissive mirror 56 and the external light OL passed through the compensation flat plate 55 are incident at the pupil position PP. In other words, the wearer US wearing the first virtual image display device 100A can observe a virtual image of the video light ML superimposed on an external image.

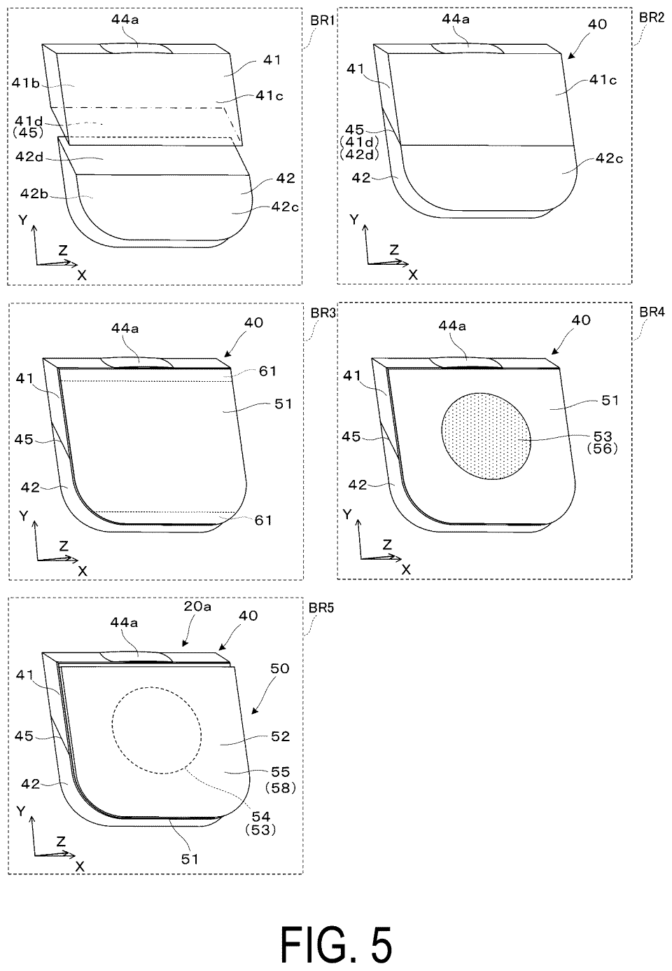

An example of the structure and assembly of the first display unit 20a constituting the first virtual image display device 100A will be described with reference to FIG. 5. In FIG. 5, regions BR1 to BR5 are perspective views for describing an assembly process of the first display unit 20a. First, as illustrated in the region BR1, the first prism 41 and the second prism 42 are prepared. The first prism 41 and the second prism 42 are made of an optical glass such as s-NBH51. The second lens 44 may be bonded to the first prism 41 in advance. The first prism 41 is formed with the incident optical surface 44a of the second lens 44, the inner surface 41b, the outer surface 41c, and the like. The second prism 42 is formed with the inner surface 42b, the outer surface 42c, and the like. Among these, the first prism 41 is formed with the polarized light separation film 45 on the inclined surface 41d by vacuum vapor deposition or other methods. As illustrated in the region BR2, the first prism 41 and the second prism 42 are bonded at the inclined surfaces 41d and 42d to obtain the first flat plate member 40. Next, as illustrated in the region BR3, the quarter-wavelength plate 51 is bonded so as to face the outer surfaces 41c and 42c of the first flat plate member 40. At this time, a pair of spacers 61 made of thin adhesives are disposed between the outer surfaces 41c and 42c of the first flat plate member 40 and the quarter-wavelength plate 51, and a gap is formed between the outer surfaces 41c and 42c of the first flat plate member 40 and the quarter-wavelength plate 51. As illustrated in the region BR4, the third lens 53 is attached at an appropriate position on the surface of the quarter-wavelength plate 51. The transmissive mirror 56 is formed on the surface of the third lens 53. Next, the optical element 58 is bonded to the quarter-wavelength plate 51 and the like. At this time, the compensation lens 54 and the third lens 53 of the optical element 58 are positioned and fitted to each other to be boned to each other. Additionally, the compensation flat plate 55 and the quarter-wavelength plate 51 of the optical element 58 are bonded to each other. By doing this process, the assembly of the first display unit 20a is completed.

In the above description, the first display unit 20a is produced such that the second flat plate member 50 is assembled on the first flat plate member 40. However, the first flat plate member 40 and the second flat plate member 50 may be separately assembled, and the first flat plate member 40 and the second flat plate member 50 may be finally bonded to each other.

The virtual image display device 100A, 100B or the optical unit 100 according to the first embodiment is, as described above, a direct virtual image type of virtual image display device including the display element 11 configured to emit the video light ML, the first lens 30 having a positive refractive power, the first lens 30 on which the video light ML from the display element 11 is incident, the second lens 44 on which the video light ML passed through the first lens 30 is incident, the first prism 41 bonded to the second lens 44, on which the video light ML passed through the second lens 44 is incident, the second prism 42 bonded to the first prism 41, the second prism 42 forming the prism light-guiding member 48 having the parallel flat plate shape, the polarized light separation film 45 provided at a bonding position of the first prism 41 and the second prism 42, the polarized light separation film 45 having a flat surface shape, the polarized light separation film 45 being configured to selectively reflect the video light ML guided in the first prism 41 in accordance with a polarization direction, the third lens 53 including the flat surface 53f disposed facing the outer surface 41c of the first prism 41, the third lens 53 having the plano-convex shape, on which the video light ML reflected at the polarized light separation film 45 is incident, the transmissive mirror 56 formed on the convex surface 53g of the third lens 53, the transmissive mirror 56 being configured to partially reflect the video light ML reflected at the polarized light separation film 45 toward the polarized light separation film 45, the quarter-wavelength plate 51 disposed between the outer surface 41c of the first prism 41 and the flat surface 53f of the third lens 53, the quarter-wavelength plate 51 being for the video light ML, and the compensation lens 54 including the concave surface 54f having a shape obtained by inverting the convex surface 53g of the third lens 53, the concave surface 54f being bonded to the convex surface 53g through the transmissive mirror 56, and the flat surface 55g parallel to the outer surface 41c of the first prism 41.

In the virtual image display device 100A, 100B or the optical unit 100, in order to directly form a virtual image without forming an intermediate image, a refractive power is ensured by using the first lens 30, the second lens 44, the third lens 53, and the transmissive mirror 56, and furthermore, the refractive indices of the first prism 41 and the second prism 42 are set to be relatively high, resulting in ensuring a magnification rate while suppressing an increase in optical path length, and avoiding an increase in size of the optical system.

In addition, with the virtual image display device 100A, 100B or the optical unit 100 described above, color aberration can be suppressed. Generally speaking, a refractive index of a material that transmits and refracts light is different depending on the wavelength of the light. Even for the same material, its refractive index is higher for a longer wavelength component such as red and lower for a shorter wavelength component such as blue. For this reason, when light including a plurality of different wavelengths passes through a substance and is refracted, an imaging position varies depending on a wavelength component. Such a phenomenon is called dispersion, and a color shift caused by the dispersion in an image formed by passing through a certain optical system is called color aberration of the optical system. One example of an index for evaluating the dispersion is an Abbe number. A refractive index and an Abbe number for each substance generally tend to be such that a substance with a lower refractive index has a higher Abbe number and a substance with a higher refractive index has a lower Abbe number. The Abbe number is defined based on the refractive index, and thus varies depending on the wavelength. Here, as an example, the refractive index and the Abbe number with respect to light having a wavelength of 587.56 nm, which is called a Fraunhofer d-line, are used.

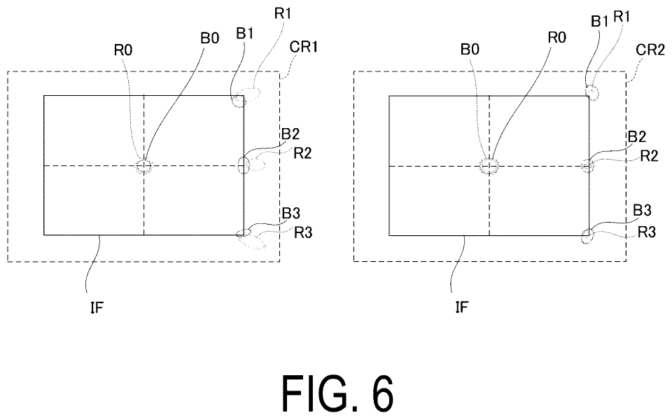

As an example, as illustrated in the region CR1 in FIG. 6, in the video light ML generated by the display element 11, even when in a central portion of an image frame IF where the video light ML is observed, a relatively long-wavelength component R0 such as red and a relatively short-wavelength component B0 such as blue are observed at substantially the same position even in reaching the pupil position PP of the wearer US, relatively long-wavelength components R1, R2, and R3 such as red and relatively short-wavelength components B1, B2, and B3 such as blue may be observed at shifted positions in a peripheral portion away from the central portion. As a result, image quality of the observed video light ML may be deteriorated.

As a method of suppressing such color aberration, for example, a method called achromat is known. With the achromat, color aberration at at least two different wavelengths can be suppressed by using a combination of a plurality of optical systems having different refractive indices with respect to the same wavelength. In the present embodiment, when a plurality of optical elements are combined, by appropriately setting a combination of differences in refractive index and Abbe number and a difference in power, color aberration at at least two different wavelengths corresponding to red and blue, for example, is reduced. As described above, in the present embodiment, a plurality of different combinations of refractive indices, Abbe numbers, and powers among the first lens 30, the second lens 44, the third lens 53, the first prism 41, and the second prism 42 are used to at least partially cancel vertical and/or horizontal color aberrations in the optical system as a whole.

More specifically, according to the present embodiment, as illustrated in the region CR2 in FIG. 6, in the virtual image display device 100A, 100B or the optical unit 100, the refractive indices of the first lens 30, the second lens 44, the first prism 41, and the third lens 53 are appropriately set based on the dimensions and shapes of the first lens 30, the second lens 44, the first prism 41, the third lens 53 and the transmissive mirror 56, which can suppress, as a whole, color aberration due to the combination of the first lens 30, the second lens 44, the first prism 41, the polarized light separation film 45, the third lens 53, and the transmissive mirror 56. From this viewpoint, the refractive indices of the first prism 41 and the second prism 42 are preferably higher than the refractive indices of the first lens 30, the second lens 44, and the third lens 53. Further, the Abbe numbers of the first prism 41 and the second prism 42 are preferably lower than the Abbe numbers of the first lens 30, the second lens 44, and the third lens 53. As an example, the Abbe numbers of the first lens 30, the second lens 44, and the third lens 53 may be equal to or more than 60 and equal to or less than 70, and the Abbe numbers of the first prism 41 and the second prism 42 may be equal to or more than 18 and equal to or less than 28.

### Second Embodiment

A virtual image display device and the like according to a second embodiment will be described below. Note that the virtual image display device according to the second embodiment is obtained by partially modifying the virtual image display device according to the first embodiment, and description of portions in common with those of the virtual image display device according to the first embodiment will be omitted.

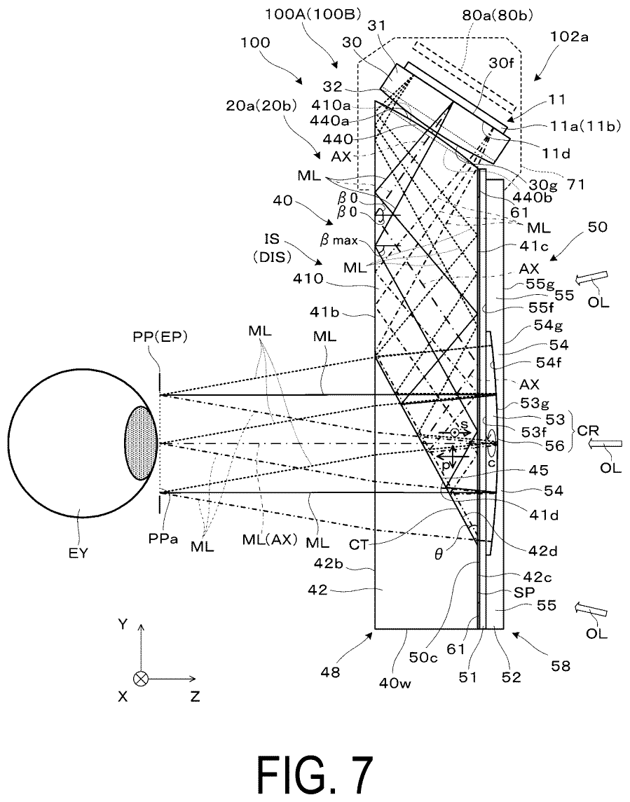

The first virtual image display device 100A illustrated in FIG. 7 is obtained by replacing the first prism 41 and the second lens 44 boned to each other in the first virtual image display device 100A illustrated in FIG. 2 with a first prism 410 integrated with a lens portion 440 and further changing the material of the first prism 410 and the second prism 42 to a plastic. A portion of the first prism 410, which is illustrated in FIG. 7, excluding the lens portion 440 has the same shape as that of the first prism 41 in FIG. 2. In addition, the lens portion 440 in FIG. 7 has the same shape as that of the second lens 44 in FIG. 2, but a refractive index and an Abbe number of the lens portion 440 are equal to a refractive index and an Abbe number of the first prism 410, respectively. An incident optical surface 440a included in the lens portion 440 in FIG. 7 corresponds to the incident optical surface 44a included in the second lens 44 in FIG. 2, and faces the first lens 30. The inclined surface 44b included in the second lens 44 in FIG. 2 and the inclined surface 41a included in the first prism 41 in FIG. 2 correspond to virtual boundary planes 440b and 410a between the lens portion 440 and a portion other than the lens portion 440 in the first prism 410 in FIG. 7, respectively.

In the virtual image display device and the like according to the second embodiment, since the first prism 410 integrated with the lens portion 440 and the second prism 42 are made of a plastic, it is possible to improve safety against breakage or the like and to reduce weight and cost as compared with a case where the first prism 410 and the second prism 42 are made of an optical glass. In addition, selecting a plastic having an appropriate refractive index and an appropriate Abbe number as the material of the first prism 410 and the second prism 42 makes it possible to suppress, as a whole, color aberration due to the combination of the first lens 30, the second lens 44, the first prism 41, the polarized light separation film 45, the third lens 53, and the transmissive mirror 56. As an example, the material of the first prism 410 and the second prism 42 may be a plastic such as EP9000 with a refractive index of 1.67 and an Abbe number of 19.

### Third Embodiment

A virtual image display device and the like according to a third embodiment will be described below. Note that the virtual image display device according to the third embodiment is obtained by partially modifying the virtual image display device according to the first embodiment, and description of parts in common with those of the virtual image display device according to the first embodiment will be omitted.

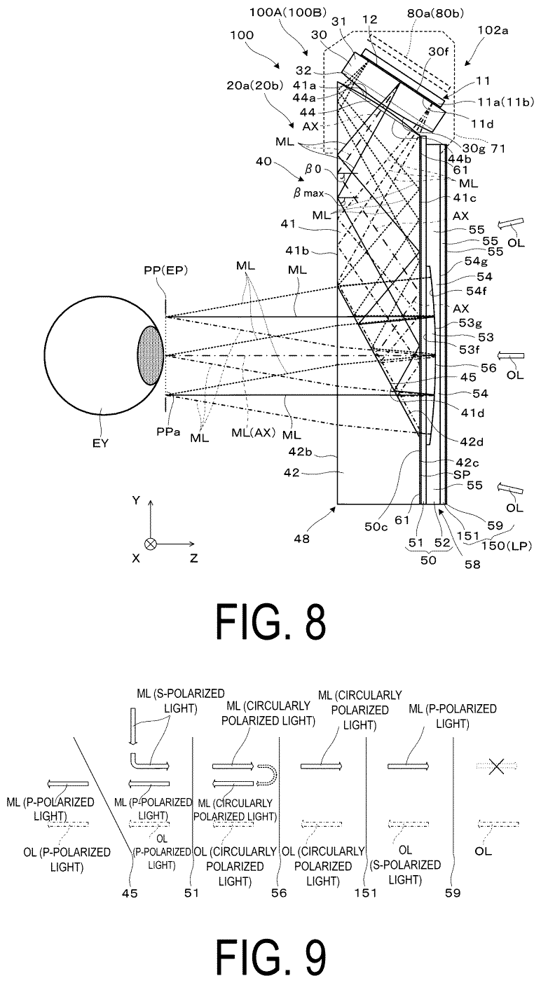

In the case of the first virtual image display device 100A illustrated in FIG. 8, in the first display unit 20a, for example, an s-polarized light transmissive polarizing plate 12 is disposed between the first lens 30 and the first image forming element 11a. However, the s-polarized light transmissive polarizing plate 12 is not essential for the function. In addition, in the first display unit 20a, a third flat plate member 150 is added to the second flat plate member 50 on an external environment side. The third flat plate member 150 is a video light blocking portion LP and includes a quarter-wavelength plate 151 positioned on the outer side and provided on the external environment side of the optical condensing/reflecting portion and a polarizing plate 59 that is provided on the external environment side of the quarter-wavelength plate 151 positioned on the outer side and that selectively absorbs the video light ML transmitted through the quarter-wavelength plate 151 positioned on the outer side in accordance with the polarization direction. That is, in the first display unit 20a, the quarter-wavelength plate 51 positioned on the inner side and the quarter-wavelength plate 151 positioned on the outer side are disposed between the polarized light separation film 45 positioned on the inner side and the polarizing plate 59 positioned on the outer side.

Referring to FIG. 9, the video light ML from the first image forming element 11a (see FIG. 8) includes only s-polarized light s, and the video light ML of the s-polarized light s incident on the polarized light separation film 45 is reflected at the polarized light separation film 45 without waste, passes through the quarter-wavelength plate 51 positioned on the inner side to become circularly polarized light c, and is incident on the transmissive mirror 56. The video light ML of the circularly polarized light c incident on the transmissive mirror 56 is partially reflected at the transmissive mirror 56 and passes through the quarter-wavelength plate 51 positioned on the inner side again in the reverse direction. The video light ML passed through the quarter-wavelength plate 51 positioned on the inner side in the reverse direction becomes p-polarized light p, passes through the polarized light separation film 45, and is incident at the pupil position PP (see FIG. 8). On the other hand, the video light ML of the circularly polarized light c transmitted through the transmissive mirror 56 becomes p-polarized light p by passing through the quarter-wavelength plate 151 positioned on the outer side, is incident on the polarizing plate 59, and is mostly blocked by the polarizing plate 59. That is, the video light ML is blocked by the third flat plate member 150 and does not leak to the outside. That is, since the video light ML can be prevented from being observed from the outside, which can ensure privacy.

On the other hand, the external light OL incident on the polarizing plate 59 becomes only s-polarized light s by passing through the polarizing plate 59, becomes circularly polarized light c by passing through the quarter-wavelength plate 151 positioned on the outer side, and partially passes through the transmissive mirror 56. The external light OL of the circularly polarized light c partially transmitted through the transmissive mirror 56 becomes p-polarized light p by passing through the quarter-wavelength plate 51 positioned on the inner side, is transmitted through the polarized light separation film 45, and is incident on the pupil position PP (see FIG. 8).

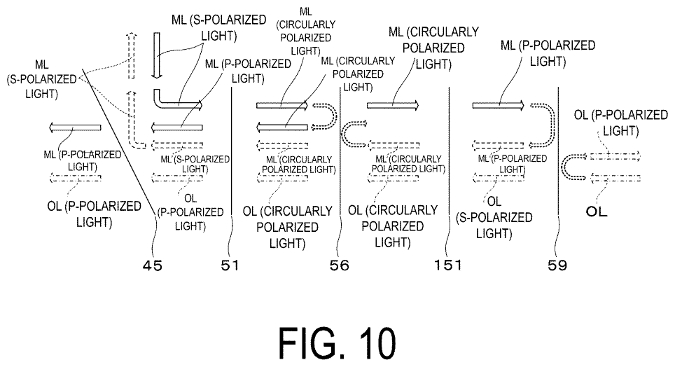

FIG. 10 is a diagram for describing a modification of the first virtual image display device 100A illustrated in FIG. 8 and FIG. 9. In this case, it is assumed that the polarizing plate 59 constituting the third flat plate member 150 illustrated in FIG. 8 transmits s-polarized light s and reflects p-polarized light p.

FIG. 10 is different from FIG. 9 in that the video light ML of circularly polarized light c partially transmitted through the transmissive mirror 56 becomes p-polarized light p by passing through the quarter-wavelength plate 151 positioned on the outer side, and is mostly reflected at the polarizing plate 59 and does not leak to the outside of the polarizing plate 59. Note that the video light ML of the p-polarized light p reflected by the polarizing plate 59 passes through the quarter-wavelength plate 151 positioned on the outer side again in the reverse direction. The video light ML of the p-polarized light p passed through the quarter-wavelength plate 51 positioned on the outer side becomes circularly polarized light c and is partially reflected at the transmissive mirror 56, but does not pass through the polarizing plate 59. The video light ML of the circularly polarized light c partially transmitted through the transmissive mirror 56 passes through the quarter-wavelength plate 51 positioned on the inner side again in the reverse direction. The video light ML passed through the quarter-wavelength plate 51 positioned on the inner side becomes s-polarized light s, is reflected at the polarized light separation film 45, and is returned in the direction of the first image forming element 11a.

On the other hand, the external light OL incident on the polarizing plate 59 becomes only s-polarized light s by passing through the polarizing plate 59, becomes circularly polarized light c by passing through the quarter-wavelength plate 151 positioned on the outer side, and partially passes through the transmissive mirror 56. The external light OL of the circularly polarized light c partially transmitted through the transmissive mirror 56 becomes p-polarized light p by passing through the quarter-wavelength plate 51 positioned on the inner side, is transmitted through the polarized light separation film 45, and is incident on the pupil position PP (see FIG. 8). Note that although the p-polarized light p of the external light OL is reflected at the polarizing plate 59, there is no particular problem, and it is rather possible to prevent the surface of the first display unit 20a from becoming too dark.

### Modifications and Others

Although the present disclosure has been described with reference to the above-described embodiments, the present disclosure is not limited to the above-described embodiments and can be implemented in various modes without departing from the spirit of the disclosure. For example, the following modifications are possible.

Although the HMD 200 includes the first virtual image display device 100A and the second virtual image display device 100B in the above description, the HMD 200 may be configured such that a single virtual image display device of the first virtual image display device 100A or the second virtual image display device 100B is supported in front of the eyes by the support devices 100C.

In the cover member 52, the compensation flat plate 55 can be omitted. In this case, the quarter-wavelength plate 51 is disposed only in the range of the third lens 53, and the third lens 53 is covered with the compensation lens 54.

The first lens 30 is not limited to a lens bonded to the first image forming element 11a, and may be a lens disposed separately from the first image forming element 11a.

The first image forming element 11a may be a scanning-type display device including a laser light source or a scanner mirror.

According to a specific aspect of the present disclosure, there is provided a virtual image display device being a direct virtual image type, the virtual image display device including a display element configured to emit video light, a first lens having a positive refractive power, on which the video light from the display element is incident, a second lens having a positive refractive power, on which the video light passed through the first lens is incident, a prism light-guiding member including a first prism and a second prism, the prism light-guiding member having a parallel flat plate shape, the prism light-guiding member being configured to cause the video light passed through the second lens to be guided, a polarized light separation film provided at a bonding position of the first prism and the second prism, the polarized light separation film having a flat surface shape, the polarized light separation film being configured to selectively reflect the video light guided in the first prism in accordance with a polarization direction, a third lens including a flat surface disposed facing an outer surface of the first prism, the third lens having a plano-convex shape, on which the video light reflected at the polarized light separation film is incident, a transmissive mirror formed on a convex surface of the third lens, the transmissive mirror being configured to partially reflect the video light reflected at the polarized light separation film toward the polarized light separation film, and a quarter-wavelength plate disposed between the outer surface of the first prism and the flat surface of the third lens, the quarter-wavelength plate being for the video light. A refractive index of the first prism is higher than refractive indices of the first lens and the third lens. The virtual image display device suppresses, as a whole, color aberration due to combination of the first lens, the second lens, the first prism, and the third lens.

In the virtual image display device described above, in order to directly form a virtual image without forming an intermediate image, a refractive power is ensured by using the first lens, the second lens, and the transmissive mirror, which makes it possible to ensure a magnification rate while suppressing an increase in length of an optical path and to avoid an increase in size of the optical system. In the virtual image display device described above, the first prism having a high refractive index is combined with the first lens and the third lens each of which has a low refractive index, resulting in suppressing color aberration.

In the virtual image display device according to the specific aspect, an Abbe number of the first prism is lower than Abbe numbers of the first lens and the third lens. In the virtual image display device, combining the first lens and the third lens having the Abbe numbers different from the Abbe number of the first prism with the first prism makes it possible to suppress color aberration.

In the virtual image display device according to the specific aspect, a difference between a refractive index of the first prism and the second prism and a refractive index of the first lens is equal to or more than 0.17, and a difference between the refractive index of the first prism and the second prism and the refractive index of the third lens is equal to or more than 0.17.

In the virtual image display device according to the specific aspect, a refractive index of the first lens is equal to or less than 1.49, a refractive index of the first prism and the second prism is equal to or more than 1.67, and a refractive index of the third lens is equal to or less than 1.49.

In the virtual image display device according to the specific aspect, the first lens and the second lens are made of a quartz having a refractive index of 1.46, the first prism and the second prism are made of an optical glass having a refractive index of 1.67, the third lens is made of an acrylic having a refractive index of 1.49, and the second lens and the first prism are bonded to each other.

In the virtual image display device according to the specific aspect, the first lens is made of a quartz having a refractive index of 1.46, the second lens, the first prism, and the second prism are made of a plastic having a refractive index of 1.67, the third lens is made of an acrylic having a refractive index of 1.49, and the second lens and the first prism are integrated with each other.

In the virtual image display device according to the specific aspect, the first lens, the prism light-guiding member, the polarized light separation film, the second lens, the transmissive mirror, and the quarter-wavelength plate constitute an imaging optical system of a simple microscope type configured to form an erect image, and the first prism internally reflects the video light twice while diverging the video light. In this case, a distance from the display element to the transmissive mirror can be easily shortened, the prism light-guiding member can be miniaturized, and the display element and the first lens can also be easily miniaturized.

In the virtual image display device according to the specific aspect, the quarter-wavelength plate for the video light is disposed away from the outer surface of the first prism. In this case, it is easy to ensure internal reflection of the video light at the outer surface of the first prism.

In the virtual image display device according to the specific aspect, an interval between the quarter-wavelength plate for the video light and the outer surface of the first prism is from 20 μm to 50 μm.

In the virtual image display device according to the specific aspect, the first lens includes a light incident surface being a flat surface, the light incident surface being bonded to the display element, and a light emission surface being a convex surface. In this case, the first lens can function as a protective glass, and ensuring a thickness of the first lens to be equal to or larger than a predetermined thickness causes a foreign matter adhering to the surface of the first lens, that is, the convex surface to be less noticeable.

In the virtual image display device according to the specific aspect of the present disclosure, the polarized light separation film reflects the video light of s-polarized light, and transmits the video light of p-polarized light obtained by reflecting the video light at the transmissive mirror, and returning the video light through the quarter-wavelength plate.

According to a specific aspect, there is provided an optical unit being a direct virtual image type, the optical unit including a first lens having a positive refractive power, on which video light from a display element configured to emit the video light is incident, a second lens having a positive refractive power, on which the video light passed through the first lens is incident, a prism light-guiding member including a first prism and a second prism, the prism light-guiding member having a parallel flat plate shape, the prism light-guiding member being configured to cause the video light passed through the second lens to be guided, a polarized light separation film provided at a bonding position of the first prism and the second prism, the polarized light separation film having a flat surface shape, the polarized light separation film being configured to selectively reflect the video light guided in the first prism in accordance with a polarization direction, a third lens including a flat surface disposed facing an outer surface of the first prism, the third lens having a plano-convex shape, on which the video light reflected at the polarized light separation film is incident, a transmissive mirror formed on a convex surface of the third lens, the transmissive mirror being configured to partially reflect the video light reflected at the polarized light separation film toward the polarized light separation film, and a quarter-wavelength plate disposed between the outer surface of the first prism and the flat surface of the third lens, the quarter-wavelength plate being for the video light. A refractive index of the first prism is higher than refractive indices of the first lens and the third lens. The optical unit suppresses, as a whole, color aberration due to combination of the first lens, the second lens, the first prism, and the third lens.

What is claimed is:

1. A virtual image display device being a direct virtual image type, the virtual image display device comprising:
a display element configured to emit video light;
a first lens having a positive refractive power, on which the video light from the display element is incident;
a second lens having a positive refractive power, on which the video light passed through the first lens is incident;
a prism light-guiding member including a first prism and a second prism, the prism light-guiding member having a parallel flat plate shape, the prism light-guiding member being configured to cause the video light passed through the second lens to be guided;
a polarized light separation film provided at a bonding position of the first prism and the second prism, the polarized light separation film having a flat surface shape, the polarized light separation film being configured to selectively reflect the video light guided in the first prism in accordance with a polarization direction;
a third lens including a flat surface disposed facing an outer surface of the first prism, the third lens having a plano-convex shape, on which the video light reflected at the polarized light separation film is incident;
a transmissive mirror formed on a convex surface of the third lens, the transmissive mirror being configured to partially reflect the video light reflected at the polarized light separation film toward the polarized light separation film; and
a quarter-wavelength plate disposed between the outer surface of the first prism and the flat surface of the third lens, the quarter-wavelength plate being for the video light, wherein
a refractive index of the first prism is higher than refractive indices of the first lens and the third lens, and
color aberration due to combination of the first lens, the second lens, the first prism, and the third lens is suppressed as a whole.

2. The virtual image display device according to claim 1, wherein
an Abbe number of the first prism is lower than Abbe numbers of the first lens and the third lens.

3. The virtual image display device according to claim 1, wherein
a difference between a refractive index of the first prism and the second prism and a refractive index of the first lens is equal to or more than 0.17, and
a difference between a refractive index of the first prism and the second prism and a refractive index of the third lens is equal to or more than 0.17.

4. The virtual image display device according to claim 1, wherein
a refractive index of the first lens is equal to or less than 1.49,
a refractive index of the first prism and the second prism is equal to or more than 1.67, and
a refractive index of the third lens is equal to or less than 1.49.

5. The virtual image display device according to claim 1, wherein
the first lens and the second lens are made of a quartz having a refractive index of 1.46,
the first prism and the second prism are made of an optical glass having a refractive index of 1.67,
the third lens is made of an acrylic having a refractive index of 1.49, and
the second lens and the first prism are bonded to each other.

6. The virtual image display device according to claim 1, wherein
the first lens is made of a quartz having a refractive index of 1.46,
the second lens, the first prism, and the second prism are made of a plastic having a refractive index of 1.67,
the third lens is made of an acrylic having a refractive index of 1.49, and
the second lens and the first prism are integrated with each other.

7. The virtual image display device according to claim 1, wherein
the first lens, the prism light-guiding member, the polarized light separation film, the third lens, the transmissive mirror, and the quarter-wavelength plate constitute an imaging optical system of a simple microscope type configured to form an erect image, and
the first prism internally reflects the video light twice while diverging the video light.

8. The virtual image display device according to claim 1, wherein
the quarter-wavelength plate for the video light is disposed away from the outer surface of the first prism.

9. The virtual image display device according to claim 8, wherein
an interval between the quarter-wavelength plate for the video light and the outer surface of the first prism is from 20 μm to 50 μm.

10. The virtual image display device according to claim 1, wherein
the first lens includes a light incident surface being a flat surface, the light incident surface being bonded to the display element, and a light emission surface being a convex surface.

11. The virtual image display device according to claim 1, wherein
the polarized light separation film reflects the video light of s-polarized light, and transmits the video light of p-polarized light obtained by reflecting the video light at the transmissive mirror, and returning the video light through the quarter-wavelength plate.

12. An optical unit being a direct virtual image type, the optical unit comprising:
a first lens having a positive refractive power, on which video light from a display element configured to emit the video light is incident;
a second lens having a positive refractive power, on which the video light passed through the first lens is incident;
a prism light-guiding member including a first prism and a second prism, the prism light-guiding member having a parallel flat plate shape, the prism light-guiding member being configured to cause the video light passed through the second lens to be guided;
a polarized light separation film provided at a bonding position of the first prism and the second prism, the polarized light separation film having a flat surface shape, the polarized light separation film being configured to selectively reflect the video light guided in the first prism in accordance with a polarization direction;
a third lens including a flat surface disposed facing an outer surface of the first prism, the third lens having a plano-convex shape, on which the video light reflected at the polarized light separation film is incident;
a transmissive mirror formed on a convex surface of the third lens, the transmissive mirror being configured to partially reflect the video light reflected at the polarized light separation film toward the polarized light separation film; and
a quarter-wavelength plate disposed between the outer surface of the first prism and the flat surface of the third lens, the quarter-wavelength plate being for the video light, wherein
a refractive index of the first prism is higher than refractive indices of the first lens and the third lens, and
color aberration due to combination of the first lens, the second lens, the first prism, and the third lens is suppressed as a whole.
